(19) United States
(12) Patent Application Publication
(10) Pub. No.: US 2024/0402798 A1
(43) Pub. Date: Dec. 5, 2024

(54) GAZE BASED CONTROLS FOR ELECTRONIC DEVICES

(71) Applicant: Apple Inc., Cupertino, CA (US)

(72) Inventors: Elena J Nattinger, Menlo Park, CA (US); Devin W. Chalmers, Oakland, CA (US); Trent A. Greene, Santa Clara, CA (US); Luis R. Deliz Centeno, Fremont, CA (US); Robert T. Held, Seattle, WA (US); Allison W. Dryer, Tiburon, CA (US)

(21) Appl. No.: 18/665,870

(22) Filed: May 16, 2024

Related U.S. Application Data
(60) Provisional application No. 63/470,033, filed on May 31, 2023.

(51) Int. Cl. G06F 3/01

(52) U.S. Cl. CPC G06F 3/013

(57) ABSTRACT

Systems and methods for controlling an electronic device using the gaze of a user. Movement of the gaze of the user to activation regions within a gaze field of view may activate a function of the electronic device. The activation regions may be dynamically modified to prevent accidental triggering of functions associated therewith.

### CROSS-REFERENCE TO RELATED APPLICATIONS

This application is a nonprovisional and claims the benefit under 35 U.S.C. 119 (e) of U.S. Provisional Patent Application No. 63/470,033, filed May 31, 2023, the contents of which are incorporated herein by reference as if fully disclosed herein.

### TECHNICAL FIELD

Embodiments described herein relate to systems and methods for controlling an electronic device using the gaze of a user.

### BACKGROUND

Electronic devices may be configured to perform one or more functions in response to user input at one or more conventional user input mechanisms such as buttons and a touch-sensitive screen. However, there may be situations in which user input via conventional user input mechanisms degrades a quality of a user experience, or is otherwise infeasible or undesirable.

### SUMMARY

Embodiments described herein relate to systems and methods for controlling an electronic device using the gaze of a user. In one embodiment, an electronic device may include a gaze tracker, a display, and a processor. The gaze tracker may be configured to detect a gaze of a user within a gaze field of view. The display may have a display area positioned to overlap a portion of the gaze field of view, and may be contained within the gaze field of view. The processor may be operably coupled to the gaze tracker and the display. The processor may be configured to detect movement of the gaze of the user to an activation region of the gaze field of view outside the display area and, in response, activate a function of the electronic device.

In one embodiment, the electronic device includes a frame containing the gaze tracker and the display. The frame may define a frame region positioned to overlap the gaze field of view and contain the display area. The frame region may be within the gaze field of view, and the activation region may be outside the frame region.

In one embodiment, the processor is configured to cause a feedback signal to be provided to the user in response to detecting the movement of the gaze of the user to the activation region. An intensity of the feedback signal may increase in relation to an amount of time the gaze of the user remains in the activation region and/or in response to a proximity of the gaze of the user to the activation region. The feedback signal may be light provided by a light source positioned in the frame in proximity to the activation region. The feedback signal may be a haptic signal and/or an audio signal.

In one embodiment, the activation region may be located in a corner of the gaze field of view. The activation region may additionally or alternatively abut an edge of the gaze field of view.

In one embodiment, the function may not be activated unless the gaze of the user remains in the activation region for at least a dwell time.

In one embodiment, an electronic device includes a gaze tracker and a processor operably coupled to the gaze tracker. The gaze tracker may be configured to detect a gaze of a user within a gaze field of view. The processor may be configured to detect movement of the gaze of the user to an activation region in the gaze field of view, determine one or more characteristics of the movement of the gaze of the user to the activation region, determine if the gaze of the user remains in the activation region for at least a dwell time, the dwell time being based on the one or more characteristics of the movement of the gaze of the user, and, in response, activate a function of the electronic device.

In one embodiment, the one or more characteristics of the movement of the gaze of the user may comprise a velocity of the movement. The dwell time may be inversely related to the velocity of the movement of the gaze of the user.

In one embodiment, the one or more characteristics of the movement of the gaze of the user may comprise a path shape of the movement of the gaze of the user from an initial point to the activation region. The dwell time may be based at least in part on a relationship between the path shape of the movement of the gaze of the user and a boundary of the activation region.

In one embodiment, the electronic device may further include a display having a display area positioned to overlap the gaze field of view. The display area may be contained within the gaze field of view. The activation region may be outside the display area.

In one embodiment, the electronic device may further include a frame containing the gaze tracker and the display. The frame may define a frame region positioned to overlap the gaze field of view. The display area may be contained within the frame region. The frame region may be contained within the gaze field of view.

In one embodiment, the activation region may be located in a corner of the gaze field of view. The activation region may additionally or alternatively abut an edge of the gaze field of view.

In one embodiment, an electronic device includes one or more sensors, a gaze tracker, and a processor. The gaze tracker may be configured to detect a gaze of a user within a gaze field of view. The processor may be operably coupled to the one or more sensors and the gaze tracker. The processor may be configured to detect movement of the gaze of the user to an activation region of the gaze field of view, modify the activation region based on one or more sensor signals from the one or more sensors, and, in response to detecting movement of the gaze of the user to the modified activation region, activate a function of the electronic device.

In one embodiment, modifying the activation region comprises enabling and disabling the activation region. The function may not be activated when the activation region is disabled.

In one embodiment, modifying the activation region may comprise changing a size of the activation region.

In one embodiment, the activation region is associated with the function of the electronic device, and modifying the activation region is based on the function of the electronic device associated with the activation region.

In one embodiment, the one or more sensor signals indicate motion of the electronic device.

In one embodiment, the one or more sensors may comprise a camera having an imaging field of view that at least partially overlaps the gaze field of view and includes the activation region. The one or more sensor signals may indicate whether the camera detects the presence of an object matching an object criterion in the activation region. The object criterion may include a type of the object, a size of the object, and a proximity of the object to the electronic device.

In one embodiment, the one or more sensor signals indicate that the user is engaged in an activity matching an activity criterion.

In one embodiment, the electronic device may further include a frame containing the gaze tracker and the display. The frame may define a frame region positioned to overlap the gaze field of view. The display area may be contained within the frame region. The frame region may be contained within the gaze field of view.

In one embodiment, the activation region may be located in a corner of the gaze field of view. The activation region may additionally or alternatively abut an edge of the gaze field of view.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a block diagram of an electronic device, such as described herein.

FIGS. 2A-21 depict diagrams illustrating portions of the physical environment from the perspective of the electronic device, such as described herein.

FIG. 3 is a flowchart depicting example operations of a method for controlling an electronic device using the gaze of a user, such as described herein.

FIG. 4 is a flowchart depicting example operations of a method for controlling an electronic device using the gaze of a user, such as described herein.

FIG. 5 is a flowchart depicting example operations of a method for controlling an electronic device using the gaze of a user, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for controlling an electronic device using the gaze of a user. In some cases, it may be difficult, infeasible, or undesirable to control an electronic device using conventional user input mechanisms such as buttons and touch-sensitive screens. For example, in cases where a user's hands are occupied or the electronic device is a head-mounted device, it may degrade the user experience to interact with the electronic device in conventional ways. Systems and methods of the present application are configured to control an electronic device using the gaze of a user.

In one example, a user may direct their gaze to an activation area within a gaze field of view to activate a function of an electronic device. The activation area may be an area within a portion of the user's gaze (e.g., the gaze field of view) that the user can look at to activate a function of the electronic device. The activation area may be, for example, a corner of the gaze field of view or an edge of the gaze field of view. For example, the user may direct their gaze to the activation area to display a graphical user interface at a display. As another example, the user may direct their gaze to the activation area to answer an incoming phone call. The gaze field of view may include multiple activation regions, each associated with a different function of the electronic device. Accordingly, the electronic device may be controlled using the gaze of the user.

In some situations, feedback may be provided to the user to assist in activating the function associated with the activation region. The feedback may be audio feedback, visual feedback, haptic feedback, combinations thereof, or the like. In some situations, the feedback may increase in intensity in relation to a proximity of the gaze of the user to the activation region and/or an amount of time the gaze of the user remains within the activation region. In one example, the electronic device includes a frame and a light source positioned in the frame in proximity to the activation region. Light may be provided from the light source to indicate when the gaze of the user is near or within the activation region. Further, an intensity of the light may increase in relation to a proximity of the gaze of the user to the activation region and/or an amount of time the gaze of the user remains within the activation region. The feedback may indicate that the function is about to be activated and give the user a chance to move their gaze or otherwise perform an action to prevent the function from being activated.

In some situations, the function of the electronic device may only be activated if the gaze of the user remains within the activation region for at least a dwell time. This may prevent the user from accidentally activating the function. The dwell time may be predefined or dynamically defined. In particular, the dwell time may be dynamically defined based on one or more characteristics of movement of the gaze of the user to the activation region. For example, a velocity of the movement of the gaze of the user to the activation region may be used to determine the dwell time, since the velocity may indicate an intention of the user to activate the function. A faster movement of the gaze of the user to the activation region may indicate with greater confidence that the user intends to activate the function than a slower movement. Accordingly, the velocity of the movement of the gaze of the user to the activation region may be inversely related to the dwell time. As another example, a path shape of the movement of the gaze of the user to the activation region may be used to determine the dwell time, since the path may indicate an intention of the user to activate the function. A direct path between an initial point of the gaze of the user and the activation region may indicate with greater confidence that the user intends to activate the function than an indirect path. Accordingly, the directness of the path shape of the movement of the gaze of the user may be inversely related to the dwell time.

In some situations, the activation region may be modified in response to a context determined by the electronic device or other information. In particular, a size of the activation region may be increased or decreased, a shape of the activation region modified, a dwell time in the activation region required to activate the function may be increased or decreased, and/or the activation region may be enabled or disabled to increase or decrease the sensitivity of the activation region for activating the function. For example, when a user is performing a certain activity such as running, a risk of the user accidentally looking towards the activation region and/or a false positive due to inaccuracy of gaze tracking hardware may be higher than usual. Accordingly, an area of the activation region may be reduced, a dwell time required to activate the function increased, and/or the activation region may be disabled when it is determined that the user is performing certain activities. Conversely, it may be desirable to make it easier to activate the function during certain activities and thus the area of the activation region may be increased, a dwell time required to active the function reduced, and/or the activation region may be enabled when it is determined the user is performing certain activities.

As another example, the activation region may be modified based on the function associated with the activation region. It may be desirable to more aggressively protect against accidental activation of certain functions of the electronic device, such as answering an incoming phone call or unlocking a front door than other functions such as displaying a graphical user interface or silencing an incoming phone call. For functions where the user wishes to avoid accidental activation more aggressively, the area of the activation region may be reduced and/or the dwell time required to activate the function increased.

As yet another example, an object of some kind may be located in the activation region. For example, a person may be located in the gaze field of view within the activation region. The user may look towards the person in the activation region without intending to activate the function. Accordingly, the activation region may be disabled when a person or other object is detected in the activation region, or the activation region may be modified to exclude the area occupied by the person or other object.

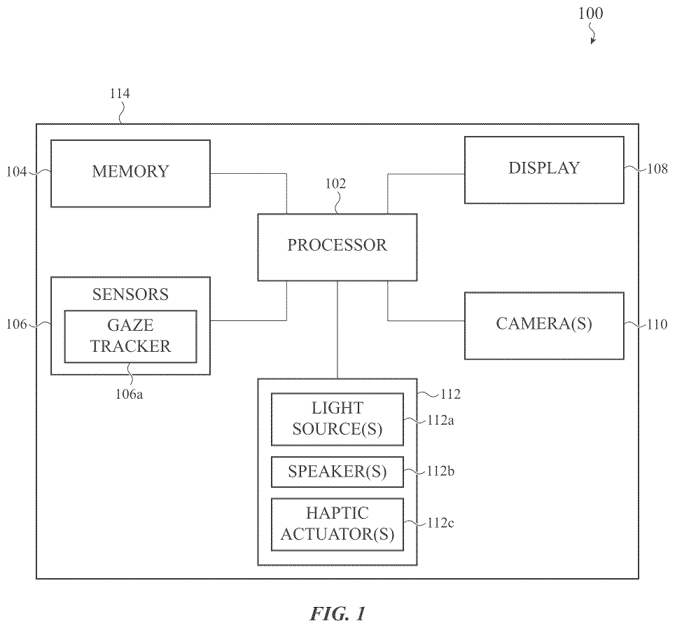

These foregoing and other embodiments are discussed below with reference to FIGS. 1-5. However, those skilled in the art will readily appreciate that the detailed description given herein with respect to these figures is for explanation only and should not be construed as limiting.

FIG. 1 is a simplified block diagram of an electronic device 100 according to one embodiment of the present disclosure. The electronic device 100 includes a processor 102, a memory 104, a number of sensors 106 including at least a gaze tracker 106a, a display 108, one or more cameras 110, and one or more feedback mechanisms 112 (e.g., one or more light sources 112a, one or more speakers 112b, one or more haptic actuators 112c, combinations thereof or the like). A frame 114 may support all or a portion of the processor 102, the memory 104, the sensors 106, the display 108, the one or more cameras 110, and the one or more feedback mechanisms 112. The memory 104, the sensors 106, the display 108, the one or more cameras 110, and the one or more feedback mechanisms 112 may be operably coupled to the processor 102. The memory 104 may include instructions, which, when executed by the processor 102 cause the electronic device 100 to perform the operations discussed herein to control the electronic device via a gaze of a user. The gaze tracker 106a may be configured to detect a location/direction of a user's gaze within a gaze field view. The gaze tracker 106a may include any suitable hardware for tracking the gaze of the user, such as one or more cameras, depth sensors, combinations thereof, or the like. The number of sensors 106 may include any number and type of sensors such as motion sensors (e.g., accelerometers, gyroscopes), light sensors, biological sensors (e.g., heart rate sensors, respiration sensors, etc.), or any other type of sensors. In some embodiments, the electronic device 100 may be a head-mounted device such as an extended-reality headset, smart glasses, or the like. However, the principles of the present disclosure apply to electronic devices having any form factor.

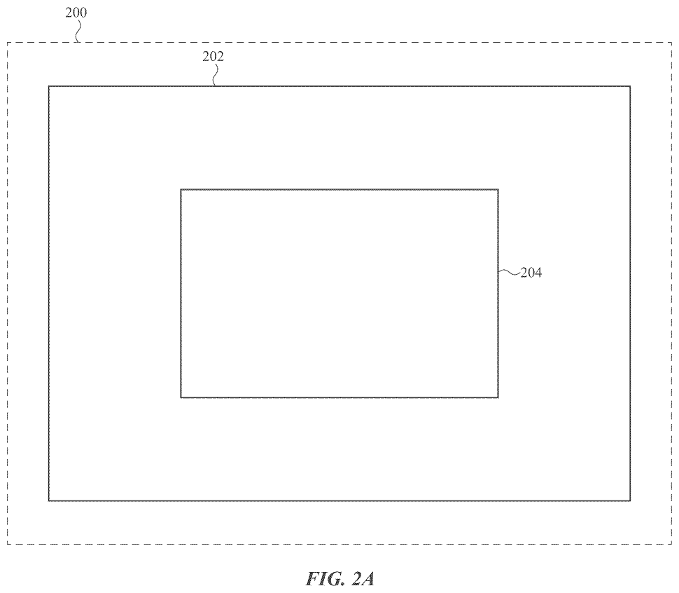

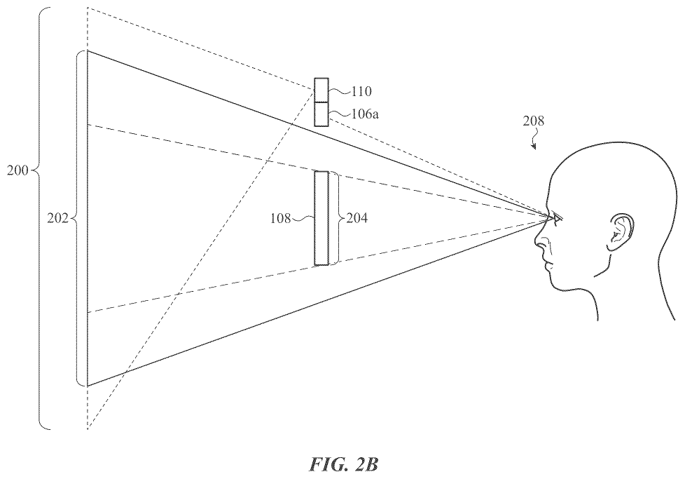

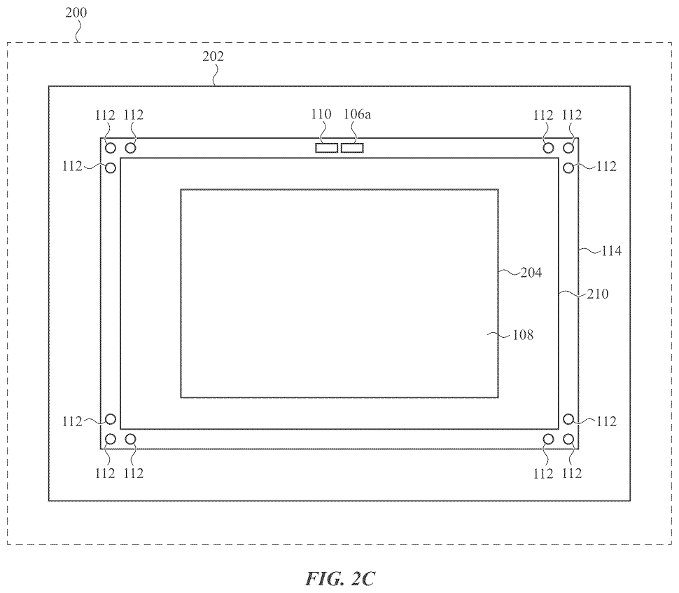

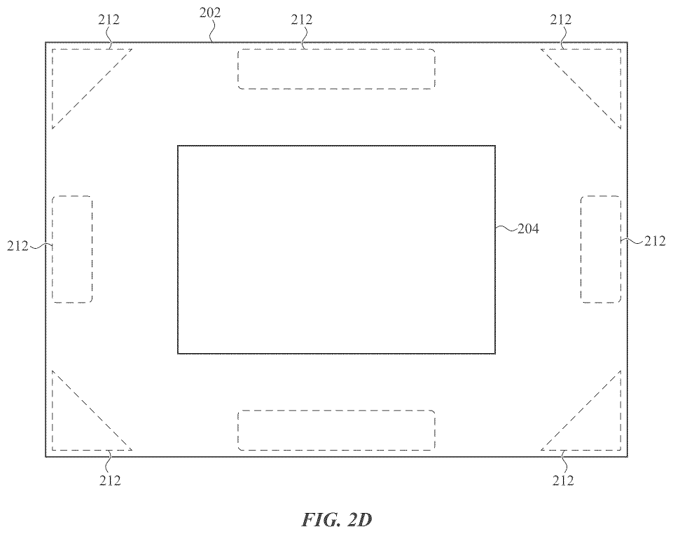

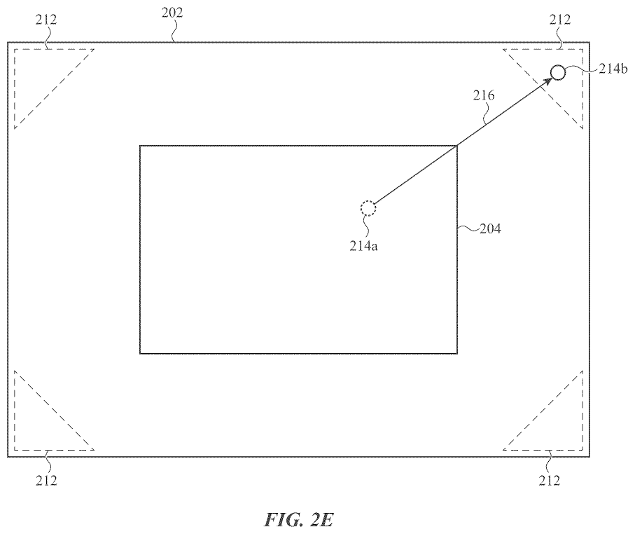

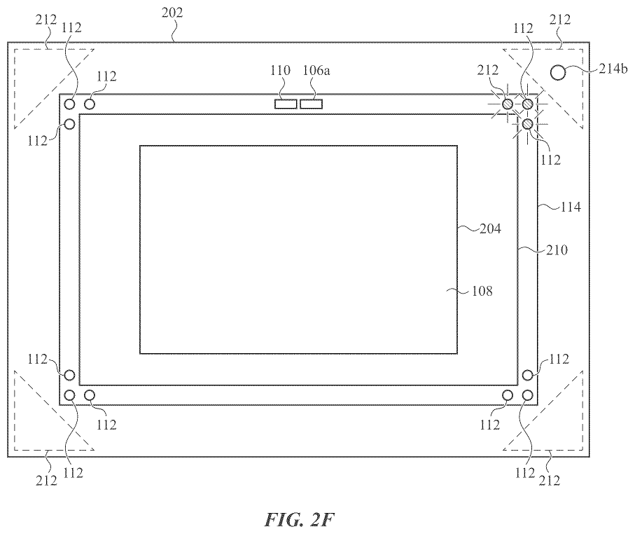

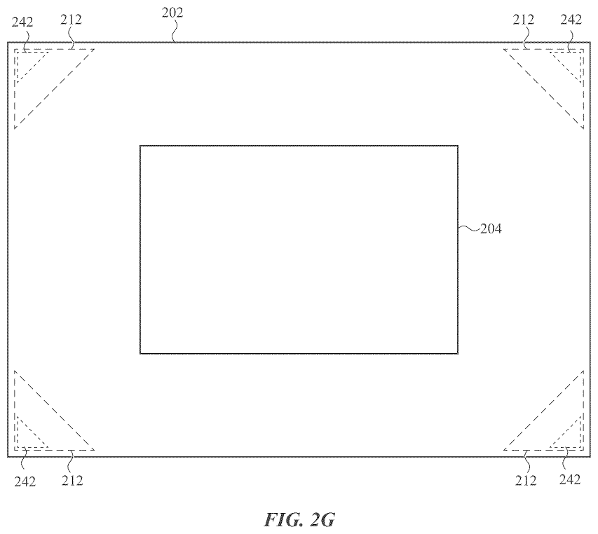

FIG. 2A is a diagram illustrating an example relationship between an object detection field of view 200, a gaze field of view 202, and a display area 204 of the electronic device 100 discussed above with respect to FIG. 1. The object detection field of view 200 may correspond to the boundaries of the environment in which the electronic device 100 is able to perceive and/or identify objects. For example, the object detection field of view 200 may correspond with a field of view of the one or more cameras 110 of the electronic device 100, or a combination of a field of view of the one or more cameras 110 and one or more other sensors such as one or more depth sensors, one or more Lidar sensors, or any other sensors for detecting and/or identifying objects in the physical environment. The gaze field of view 202 may correspond to the area over which a gaze of the user can be tracked. In some embodiments, this may correspond with the area over which the location of the gaze of the user can be determined with a desired accuracy. The gaze field of view 202 may represent all or a subset of the user's full gaze range for a given head position. As shown, the gaze field of view 202 may be a subset of the object detection field of view 200, however, this is not required. In some cases, the gaze field of view 202 may be the same size as or larger than the object detection field of view 200. The display area 204 may correspond to an area on which a graphical user interface is overlaid as viewed by a user of the electronic device 100 (e.g., when the electronic device 100 is worn as a head-mounted device). In some cases, the display area 204 may correspond to the physical boundaries of the display 108 of the electronic device 100. In some instances, the display area 108 at least partially overlaps with the object detection field of view 200 and the gaze field of view 202 As shown, the display area 204 may be smaller than both the object detection field of view 200 and the gaze field of view 202. However, this is not required, and the display area 204 may be the same size or larger than the object detection field of view 200 and/or the gaze field of view 202. The display 108 may be at least partially transparent, such that the physical environment is viewable through the display area 204, and graphical elements can be overlaid on the physical environment within the display area 204.

FIG. 2B shows the object detection field of view 200, the gaze field of view 202, and the display area 204 as they relate to a user 208 of the electronic device 100. For context, the gaze tracker 106a, the display 108, and the one or more cameras 110 are also shown. As shown, the object detection field of view 200 may correspond to a field of view of the one or more cameras 110. The gaze field of view 202 may correspond to the area in which the gaze of the user can be detected by the gaze tracker 106a. This may be limited based on constraints of the gaze tracker 106a, such as a location thereof, the capabilities thereof, or the like. The display area 204 corresponds to the location of the display 108 with respect to the user. While not shown, the display 108 may be supported by the frame 114 at a particular distance from the user 208 and at a particular location with respect to the user 208. This may determine the display area 204 as viewed by the user 208.

FIG. 2C shows the object detection field of view 200, the gaze field of view 202, and the display area 204 in relation to the frame 114 of the electronic device 100. As shown, the frame 114 physically supports the gaze tracker 106a and the one or more cameras 110. Further, the frame 114 may physically support one or more feedback mechanisms 112, which are shown in the present example as light sources embedded in the frame 114. The one or more feedback mechanisms 112 may be distributed in the frame in proximity to one or more activation regions in the gaze field of view as discussed in further detail below. The frame 114 defines a frame region 210, which may correspond with a region the user looks through when operating the electronic device 100. The frame region 210 may include at least a portion of the gaze field of view 202 and the display area 204. As discussed above, the electronic device 100 may be head-mounted device. The frame 114 may correspond to a housing of the electronic device. In one embodiment, the frame 114 has the form factor of an eyeglass frame, and one side of the frame 114 (one eyepiece) is illustrated in FIG. 2C. While the feedback mechanisms 112 are shown as light sources in the present example, the feedback mechanisms 112 may include speakers, haptic actuators, or other types of feedback mechanisms 112. Certain types of feedback mechanisms may not make sense to place in proximity to an activation region, and may be placed in other locations such as in an earpiece of the electronic device 100.

FIG. 2D shows the gaze field of view 202 including a number of activation regions 212. For context, the display area 204 is also shown, where the activation regions 212 are outside the display area 204. Providing the activation regions 212 outside the display area 204 may allow for a wider range of the gaze field of view 202 to be used for activation of functions of the electronic device 100. That is, providing the activation regions 212 outside the display area 204 may ensure that the area used for activating functions of the electronic device 100 is not limited to the display area 204. However, in some embodiments, the activation regions 212 may partially or completely overlap with the display area 204. The activation regions 212 may be located in each corner of the gaze field of view 202 as well as between corners at edges of the gaze field of view 202. Notably, the size and position of the activation regions 212 may differ depending on the implementation thereof. For example, the gaze field of view 202 may only include a subset of the activation regions 212 shown, or may include additional activation regions 212 not shown. Further, the shape and/or position of the activation regions 212 may differ without departing from the principles of the present disclosure.

The activation regions 212 may be configurable by users of the electronic device 100. For example, a user may activate or deactivate certain activation regions 212, change a size or shape of any of the activation regions 212, and as specify the function associated with a particular activation region. As discussed above, the activation regions 212 are regions in the gaze field of view 202 in which the user can direct their gaze to activate a function of the electronic device 100. Each activation region 212 may be associated with a function of the electronic device 100 such that when the user directs their gaze to the activation region 212 the associated function is activated. Different activation regions 212 may be associated with different functions. For example, a first activation region 212 may be associated with a first function to show a settings graphical user interface in the display area 204 and a second activation region 212 may be associated with a second function to activate a smart home device such as a smart light bulb.

FIG. 2E illustrates movement of the gaze of the user from a first location 214a to a second location 214b, where the first location 214a is not within an activation region 212 and the second location 214b is within an activation region 212. The electronic device 100 may be configured to detect (e.g., using gaze tracker 106a) the movement of the gaze of the user to the activation region 212 (or any other activation region 212) and, in response thereto, activate a function of the electronic device 100. For example, in response to detecting the movement of the gaze of the user to the activation region 212, the electronic device 100 may display a graphical user interface (such as a settings graphical user interface) in the display area 204. As another example, in response to detecting the movement of the gaze of the user to the activation region 212, the electronic device 100 may answer an incoming phone call, activate a voice command or virtual assistant, open an application, or perform a custom device operation specified by the user. In some situations, the gaze of the user may be required to linger in the activation region 212 for at least a dwell time before activating the function. This may reduce accidental triggering of the function associated with the activation region 212 in some circumstances.

The movement of the gaze of the user may have associated characteristics that can be measured by the electronic device 100 via the gaze tracker 106a or otherwise. For example, the movement of the gaze of the user may have an associated velocity of movement between the first location 214a and the second location 214b. As another example, the movement of the gaze of the user may track a path 216 between the first location 214a and the second location 214b. These characteristics may be indicative of an intent of the user to activate the function associated with the activation region 212. For example, a higher velocity of the movement of the gaze of the user to the second location 214b may indicate with higher confidence that the user intends to activate the function associated with the activation region 212 than a lower velocity. As another example, the movement of the gaze of the user along a direct path between the first location 214a and the second location 214b may indicate with higher confidence that the user intends to activate the function associated with the activation region 212 than a less direct path. These characteristics may be used to modify characteristics of one or more activation regions 212 to make it more or less difficult to activate the function associated therewith. For example, the characteristics of the movement of the gaze of the user may be used to determine the dwell time required in the activation region 212 before activating the function.

When the characteristics indicate a higher confidence that the user intends to activate the function, the dwell time may be decreased. Conversely, when the characteristics indicate a lower confidence that the user intends to activate the function, the dwell time may be increased. In various examples, the dwell time may be inversely related to the velocity of the movement of the gaze of the user to the activation region 212 and inversely related to the directness of the path of the movement of the gaze of the user to the activation region 212. In some embodiments, a relationship between the path shape of the movement of the gaze of the user to the activation region 212 and a boundary of the activation region 212 may be used to determine the dwell time. For example, if the path shape of the movement is largely parallel to a boundary of the activation region 212, this may indicate a lower confidence that the user intends to activate the function and the dwell time may be increased.

In some situations, it may be desirable to provide a user with feedback before activating the function associated with the activation region 212 or otherwise guiding the user in interacting with the activation regions 212. For example, one or more feedback signals such as audio signals, visual signals, haptic signals, or any other type of feedback signals, may be provided to the user before activating the function. The feedback may give the user the opportunity to prevent the function from activating, for example, by moving their gaze out of the activation region 212. FIG. 2F illustrates exemplary feedback provided to a user having their gaze in the activation region 212 via feedback mechanisms 112 in the frame 114. As shown, the feedback mechanisms 112 are light sources embedded in the frame 114 in proximity to activation regions 212 in the gaze field of view 202. The light sources near the activation region 212 in which the gaze of the user is located (as indicated by the second point 214b in the activation region 212) are providing light. This may indicate that the gaze of the user is within the activation region 212 and that the function associated with the activation region 212 is about to be activated unless the user moves their gaze or takes other action. In some situations, an intensity of the feedback provided to the user may increase in relation (e.g., proportionally) to an amount of time the gaze of the user remains within the activation region 212 or in relation (e.g., proportionally) to a proximity of the gaze of the user to the activation region 212.

For example, the intensity of the light provided by the light sources may increase the closer the gaze of the user gets to the activation region 212, or the longer the gaze of the user remains within the activation region 212. In one example, feedback having a first intensity level is provided as the gaze of the user approaches the activation region 212 and increases to a second intensity level when the gaze of the user enters the activation region 212. The feedback may increase to a third intensity level as the gaze of the user remains within the activation region 212. The intensity of the feedback may thus indicate the immediacy with which the function associated with the activation region 212 will be activated, giving the user the opportunity to avoid activation of the function if desired.

In addition to modifying the dwell time required to activate the function associated with the activation region 212, other characteristics of the activation region 212 may be modified to make it more or less difficult for the user to activate the function and thus avoid accidental activation. For example, a size of the activation region 212 may be increased or decreased as shown in FIG. 2G, in which the original activation regions 212 are replaced with updated activation regions 242 having a smaller size. While not shown, a shape of the activation region 212 may also be changed to make it more or less difficult for the user to activate the function. As the activation region 212 gets smaller, it becomes more difficult for the user to activate the function due to the smaller area over which the user must direct their gaze. Accordingly, in situations in which there is a high risk of accidental activation, such as when the location of the gaze of the user cannot be determined with a desired accuracy (e.g., when there is a large amount of movement of the electronic device 100 such as when the user is exercising), in situations in which the gaze of the user is expected to move a significant amount (e.g., when sightseeing or hiking), or any other situation, the size of the activation region 212 and/or shape of the activation region 212 may be modified to make it more difficult to activate the function associated therewith. In some situations in which the risk of accidental activation is too high, the activation region 212 may be disabled altogether, such that the function is not activated even when the gaze of the user is directed to the activation region 212 and/or lingers on the activation region 212.

The characteristics of the activation region 212 such as size, shape, enablement, or any other characteristics including dwell time, may be modified based on measurements (e.g., sensor signals such as motion sensor signals from an accelerometer and/or gyroscope) from one or more of the sensors 106. This may include the gaze tracker 106a and thus the characteristics of the movement of the gaze of the user as discussed above. Measurements from the sensors 106 may indicate a context of the user and/or the electronic device 100, such as whether the user is exercising, if the user is in a situation in which there is a high risk of accidental activation, if the user is in a situation in which certain functions are not appropriate (e.g., if the function is playing music through a speaker and the user is in a work meeting), or the like. In one example, the electronic device 100 may determine that the user is looking at a screen of an electronic device. Since the user is likely to look at any portion of the screen, any activation areas 212 overlapping with the screen may be at a high risk for accidental activation. Accordingly, one or more activation regions 212 may be modified to exclude the area occupied by the screen.

Generally, any sensors and thus any measurements may be used to determine when it is appropriate to modify the activation regions 212 to increase or decrease the difficulty of activating the associated function. In one example, sensor signals from one or more sensors may indicate that the user in engaged in an activity matching an activity criterion (e.g., that the user is exercising as discussed above). If the user is engaged in an activity matching the activity criterion, the activation region 212 may be modified. While sensor signals from one or more sensors may be used to determine a context of the user and/or electronic device 100 for modifying one or more activation regions 212, additional information may alternatively or additionally be used for the same purpose. For example, user input to the electronic device 100 or another electronic device such as a smart watch or smart phone may be used to determine a context of the user and/or electronic device 100 and thus modify one or more activation regions 212. For example, a user may interact with the electronic device 100 or another electronic device to start a workout in a workout tracking app, which may indicate that there is an increased risk of accidental activation of one or more activation regions 212 as discussed above. As another example, the user may be playing a game on another device, which may also indicate that there is an increased risk of accidental activation of the one or more activation regions 212. In general, any information collected by the electronic device 100, either directly or indirectly, may be used to determine when it is appropriate to modify one or more of the activation regions 212.

In some situations, the function associated with the activation region 212 may be used to determine one or more characteristics thereof, such as size, shape, enablement, etc. Certain functions may be associated with an increased desire to avoid accidental activation than others. For example, answering an incoming phone call may be associated with an increased desire to avoid accidental activation than silencing an incoming phone call or activating a virtual assistant. These preferences may be indicated by the user or determined by default by the device. Activation regions 212 associated with functions that are in turn associated with an increased desire to avoid accidental activation may be sized, shaped, or otherwise modified to make it more difficult to activate the function than other activation regions 212 associated with functions that are not associated with an increased desire to avoid accidental activation. Further, these activation regions 212 associated with functions that are in turn associated with an increased desire to avoid accidental activation may be disabled at a lower threshold for risk of accidental activation than other activation regions 212.

In some situations, there may be an object 218 overlapping with the activation region 212 that the user is likely to look at as shown in FIG. 2H. The user may look at the object 218 without intending to activate the function associated with the activation region 212. For example, the object 218 may be a person may be located in the activation region 212. The user may wish to look at the person, for example, to have a conversation, without activating the function associated with the activation region 212. Accordingly, FIG. 2I illustrates modification of the activation region 212 to exclude the object 218, so that the user can look at the object 218 without activating the function associated with the activation region 212. The object 218 may be detected by the one or more cameras 110 of the electronic device 100 or any other sensors 106. In some situations, only objects matching an object criterion will result in modification of the activation region 212. The object criterion may include a type of the object, a size of the object, a proximity of the object to the electronic device 100, or any other criteria. Changes to the activation region 212 (e.g., in size, shape, dwell time) may depend on the type, size, proximity, or any other characteristics of the object detected in the activation region 212.

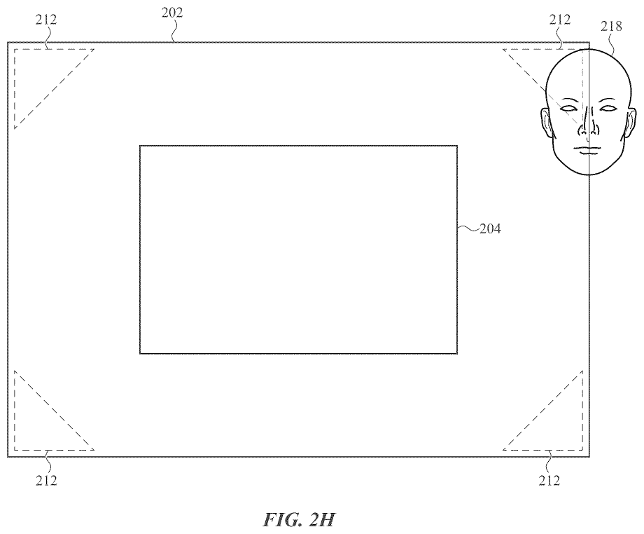

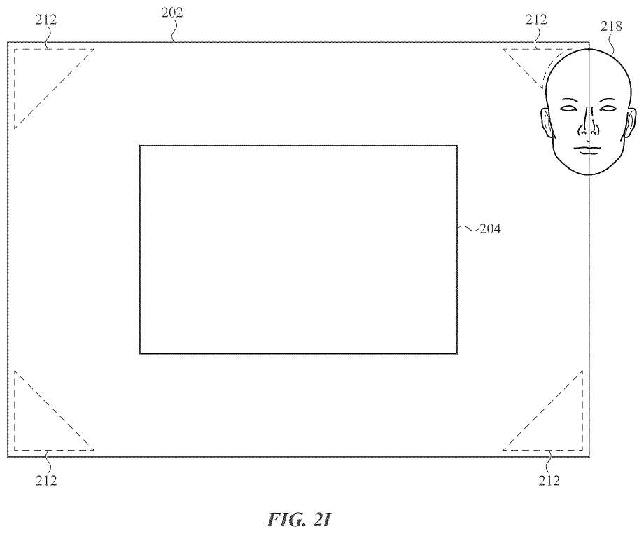

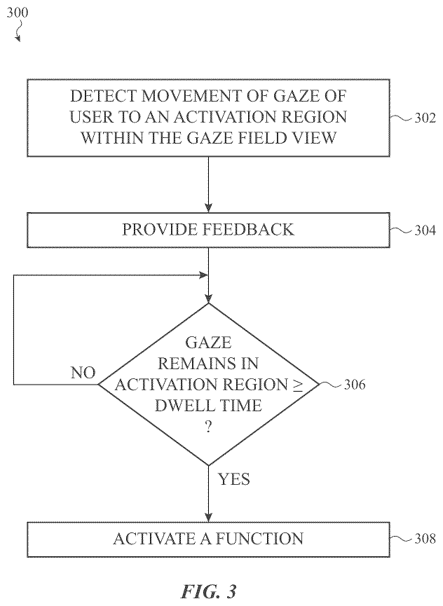

FIG. 3 is a flowchart depicting example operations of a method 300 for activating a function of an electronic device using the gaze of a user. The operations may be performed, for example, by the electronic device 100 discussed above with respect to FIG. 1. At block 302, movement of the gaze of the user to an activation region of a gaze field of view may be detected. The movement of the gaze of the user may be detected, for example, by one or more sensors such as a gaze tracker. At block 304, feedback may be provided to the user related to the relationship of the gaze of the user to the activation region. For example, feedback may be provided to the user to indicate that their gaze has entered the activation region, to indicate a proximity of their gaze to the activation region, or to indicate that a function associated with the activation region is about to be activated. The feedback may be audio, visual, haptic, or any other type of feedback. In some embodiments, an intensity of the feedback is provided in proportion to an amount of time the gaze of the user remains within the activation region, a proximity of the gaze of the user to the activation region, an immediacy of activation of the function associated with the activation region, or any other information.

At block 306, a determination may be made whether the gaze of the user remains in the activation region for an amount of time greater than or equal to a dwell time. As discussed above this may reduce the risk of accidental activation of the function associated with the activation region. If the gaze of the user remains in the activation region for at least the dwell time, or if block 306 is omitted, the function is activated at block 308. For example, a graphical user interface may be displayed at a display of the electronic device, the electronic device may communicate with a smart home device to activate the smart home device, or any other function may be performed.

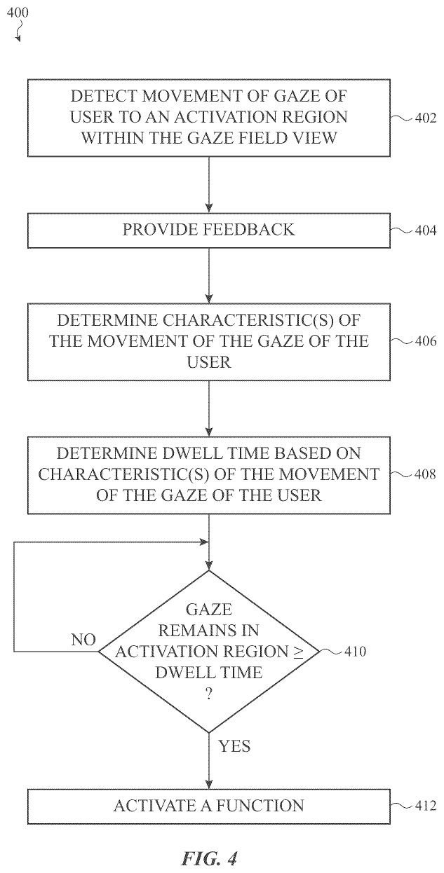

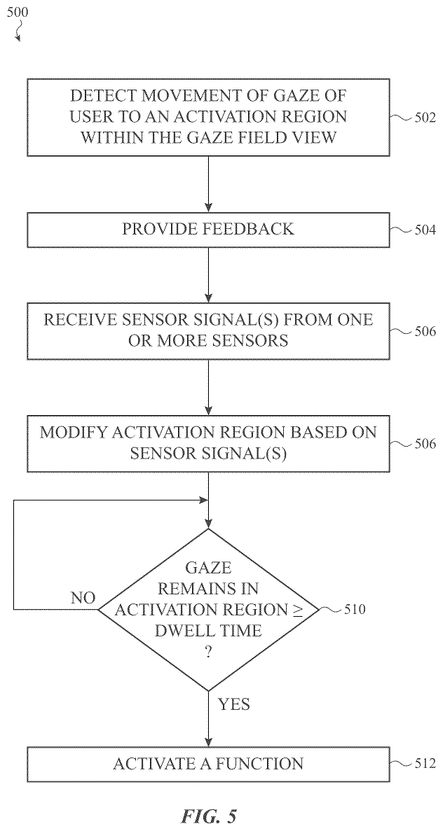

FIG. 4 is a flowchart depicting example operations of a method 400 for activating a function of an electronic device using the gaze of a user. The operations may be performed, for example, by the electronic device 100 discussed above with respect to FIG. 1. At block 402, movement of the gaze of the user to an activation region of a gaze field of view may be detected. The movement of the gaze of the user may be detected, for example, by one or more sensors such as a gaze tracker. At block 404, feedback may be provided to the user related to the relationship of the gaze of the user to the activation region as discussed above.

At block 406, one or more characteristics of the movement of the gaze of the user are determined. The one or more characteristics may include any characteristics such as, for example, velocity of the movement and a path shape of the movement from an initial point to the activation region. As discussed above, different characteristics of the movement of the gaze of the user may indicate a confidence that the user intends to activate a function associated with the activation region.

At block 408, a dwell time is determined based on the one or more characteristics of the movement of the gaze of the user. For example, when the one or more characteristics indicate a lower confidence that the user intends to activate the function associated with the activation region the dwell time may be increased, and, conversely, when the one or more characteristics indicate a higher confidence that the user intends to activate the function associated with the activation region the dwell time may be decreased.

At block 410, a determination is made whether the gaze of the user remains within the activation region for an amount of time greater than or equal to the dwell time. If the gaze of the user remains within the activation region for at least the dwell time, the function is activated at block 412 as discussed above.

FIG. 5 is a flowchart depicting example operations of a method 500 for activating a function of an electronic device using the gaze of a user. The operations may be performed, for example, by the electronic device 100 discussed above with respect to FIG. 1. At block 502, movement of the gaze of the user to an activation region of a gaze field of view may be detected. The movement of the gaze of the user may be detected, for example, by one or more sensors such as a gaze tracker. At block 504, feedback may be provided to the user related to the relationship of the gaze of the user to the activation region as discussed above.

At block 506, one or more sensor signals are received from one or more sensors. The one or more sensor signals may represent physical phenomena in the physical environment, such as movement of the user and/or the electronic device, the presence or absence of objects in front of the user and/or electronic device, or any other information.

At block 508, the activation region is modified based on the one or more sensor signals. For example, a size of the activation region, a shape of the activation region, a dwell time associated with the activation region, whether the activation region is enabled or disabled, or any other characteristics of the activation region may be modified in response to the one or more sensor signals. As discussed above, the one or more sensors signals may indicate an increased risk for accidental activation of functions associated with activation regions. Modifying characteristics of activation regions based on the sensor signals may thus decrease the likelihood of accidentally triggering functions of the electronic device.

At block 510, a determination may be made whether the gaze of the user remains in the activation region for an amount of time greater than or equal to a dwell time. If the gaze of the user remains in the activation region for at least the dwell time, or if block 510 is omitted, the function is activated at block 512 as discussed above.

These foregoing embodiments depicted in FIGS. 1-5 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

1. An electronic device, comprising:
a gaze tracker configured to detect a gaze of a user within a gaze field of view;
a display having a display area positioned to overlap a portion of the gaze field of view, the display area contained within the gaze field of view; and
a processor operably coupled to the gaze tracker and the display, the processor configured to:
detect movement of the gaze of the user to an activation region of the gaze field of view outside the display area; and
in response to detecting movement of the gaze of the user to the activation region, activate a function of the electronic device.

2. The electronic device of claim 1, further comprising:
a frame containing the gaze tracker and the display, the frame defining a frame region positioned to overlap the gaze field of view, the display area contained within the frame region, the frame region contained within the gaze field of view, wherein:
the activation region is outside the frame region.

3. The electronic device of claim 1, wherein:
the processor is configured to cause a feedback signal to be provided to the user in response to detecting the movement of the gaze of the user to the activation region.

4. The electronic device of claim 3, wherein:
an intensity of the feedback signal increases in proportion to an amount of time the gaze of the user remains in the activation region.

5. The electronic device of claim 3, wherein:
an intensity of the feedback signal increase in proportion to a proximity of the gaze of the user to the activation region.

6. The electronic device of claim 3, further comprising:
a light source positioned in the frame in proximity to the activation region, wherein:
the feedback signal is light provided by the light source.

7. The electronic device of claim 3, wherein:
the feedback signal is a haptic signal.

8. The electronic device of claim 3, wherein:
the feedback signal is an audio signal.

9. The electronic device of claim 1, wherein:
the activation region is located in a corner of the gaze field of view.

10. The electronic device of claim 1, wherein:
the activation region abuts an edge of the gaze field of view.

11. The electronic device of claim 1, wherein:
the processor is configured to activate the function in response to detecting the gaze of the user remaining in the activation region for an amount of time greater than a threshold amount of time.

12. An electronic device, comprising:
a gaze tracker configured to detect a gaze of a user within a gaze field of view; and
a processor operably coupled to the gaze tracker, the processor configured to:
detect movement of the gaze of the user to an activation region of the gaze field of view;
determine one or more characteristics of the movement of the gaze of the user to the activation region;
determine if the gaze of the user remains within the activation region for at least a dwell time, the dwell time being based on the one or more characteristics of the movement of the gaze of the user; and
in response to determining the gaze of the user remained within the activation region for at least the dwell time, activate a function of the electronic device.

13. The electronic device of claim 12, wherein the one or more characteristics of the movement of the gaze of the user comprises a velocity of the movement of the gaze of the user.

14. The electronic device of claim 13, wherein the dwell time is inversely related to the velocity of the movement of the gaze of the user.

15. The electronic device of claim 12, wherein the one or more characteristics of the movement of the gaze of the user comprises a path shape of the movement of the gaze of the user from an initial point to the activation region.

16. The electronic device of claim 15, wherein the dwell time is based at least in part on a relationship between the path shape of the movement of the gaze of the user and a boundary of the activation region.

17. The electronic device of claim 12, further comprising:
a display having a display area positioned to overlap a portion of the gaze field of view, the display area contained within the gaze field of view, the activation region outside the display area.

18. The electronic device of claim 17, further comprising:
a frame containing the gaze tracker and the display, the frame defining a frame region positioned to overlap the gaze field of view, the display area contained within the frame region, the frame region contained within the gaze field of view.

19. The electronic device of claim 12, wherein:
the activation region is located in a corner of the gaze field of view.

20. The electronic device of claim 12, wherein:
the activation region abuts an edge of the gaze field of view.

21-32. (canceled)
